(19) United States
(12) Patent Application Publication
(10) Pub. No.: US 2004/0044652 A1
(43) Pub. Date: Mar. 4, 2004

(54) Information extraction device and storage medium

(76) Inventor: Yoshiyuki Ito, Kawasaki (JP)

Correspondence Address: STAAS & HALSEY LLP, SUITE 700, 1201 NEW YORK AVENUE, N.W., WASHINGTON, DC, 20005, US

(21) Appl. No.: 09/748,370

(22) Filed: Dec. 27, 2000

(30) Foreign Application Priority Data
Jan. 31, 2000 (JP) 2000-021496

(51) Int. Cl. G06F 7/00

(52) U.S. Cl. 707/3

(57) ABSTRACT

In an information extraction device for converting a plurality of kinds of requests into requests in an XML format by referring to a database, a server receives requests from a user, a function called up from the application of the server converts the plurality of kinds of requests converts into requests in an XML format by referring to the database, extracts results from the request and notifies a user of the results. Therefore, information about the plurality of kinds of requests can be easily and rapidly extracted and can be returned to the user.

### BACKGROUND OF THE INVENTION

1. Field of the Invention

The present invention relates to an information extraction device for converting a plurality of kinds of requests into requests in an XML format by referring to a database, extracting information from the requests and replying to the requests and a storage medium thereof.

2. Description of the Related Art

Conventionally, when extracting a plurality of pieces of information from a large-size database managed by a server via a network, such as the Internet, a user (user terminal) set the extraction of a plurality of pieces of information in an object and transmitted the object to the server, and the server set a plurality of pieces of information extracted from the database in the object and returned the object. Then, the user extracted the plurality of pieces of information using an interface prepared for the object.

However, according to the conventional method described above, a range from which information can be extracted, the kind of information which can be extracted by the interface of an object, etc., are restricted, which is a problem.

### SUMMARY OF THE INVENTION

It is an object of the present invention to easily and rapidly extract information about a plurality of kinds of requests and to return the information by a server receiving requests from a user and by a function called up from the application software of the server converting the plurality of kinds of requests into requests in an XML format by referring to a database, by extracting results from the requests and returning the results to the user to solve these problems.

Means for solving the problems is described with reference to FIG. 1.

In FIG. 1, a server 2 is connected to a network and provides a variety of services. In this example, the server 2 comprises an application software 3, an XML generation function 4, etc.

Application software 3 executes a variety of processes according to a program. In this example, the application software 3 receives requests from a browser 1, transfers the received requests to the XML generation function 4, makes the XML generation function generate requests in a XML format, etc.

The XML generation function 4 converts the plurality of kinds of requests transferred from the application software 3 into requests in an XML format, etc.

A database 6 stores a variety of information in order to simplify the retrieval of information.

Next, the operation is described.

The application software 3 of the server 2 transfers requests received from the browser 1 to the XML generation function 4. The XML generation function 4 converts the transferred plurality of kinds of requests into requests in an XML format by referring to the database 6 and returns the requests to the application software 3. The application software 3 extracts information from the requests and replies to the browser 1.

At this time, a list of requests related to the generated requests in an XML format that can be arbitrarily selected or set is linked and provided.

Alternatively, a list of requests related to information designated in generated requests in an XML format that can be arbitrarily selected or set is linked and provided.

Therefore, since the server 2 receives requests from the browser 1, a function called up from the application software 3 of the server 2 converts the plurality of kinds of requests into requests in an XML format by referring to the database 6, extracting results from the requests and returning the results to the browser 1, information about a plurality of kinds of requests can be easily and rapidly extracted and can be returned to the browser 1.

### BRIEF DESCRIPTION OF THE DRAWINGS

FIG. 1 shows the system configuration of the present invention.

FIG. 2 is a flowchart showing the operation of the present invention.

FIG. 3 is a flowchart showing the detailed operation (a process for inserting property).

FIG. 4 is a flowchart showing the detailed operation (information about property).

FIG. 5 is a flowchart showing the detailed operation (a method for inserting correlation).

FIG. 6 shows examples of the requests of the present invention.

FIG. 7 shows an example of the database used in the present invention.

FIG. 8 shows an example of the XML of the present invention (Example 1).

FIG. 9 shows an example of the database used in the present invention (Example 1).

FIG. 10 shows the XML of the present invention (Example 2).

FIG. 11 shows the XML of the present invention (Example 2).

FIG. 12 shows an example of the database used in the present invention (Example 2).

FIG. 13 shows the XML of the present invention (Example 3).

FIG. 14 shows the XML of the present invention (Example 3).

FIG. 15 shows an example of the database used in the present invention (Example 3).

### DESCRIPTION OF THE PREFERRED EMBODIMENTS

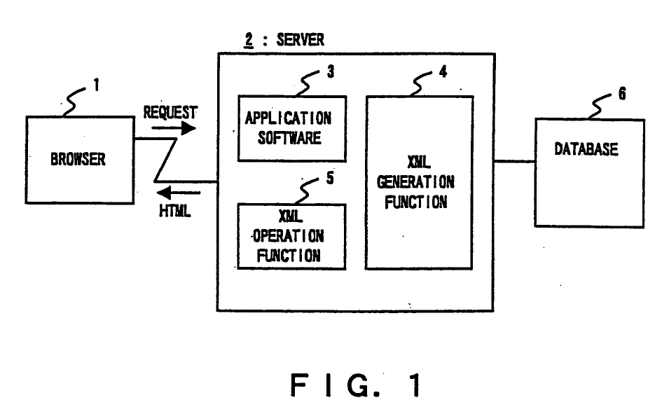

The preferred embodiments of the present invention and the operation thereof are described in detail with reference to FIGS. 1 through 15.

FIG. 1 shows the system configuration of the present invention.

In FIG. 1, the browser 1 is used for a user to transmit requests to the server 2 via a network, such as the Internet, etc., to display the returned retrieval results of the database 6, etc.

The server 2 loads a program read from a storage medium, which is not shown in FIG. 1, into a main memory, starts the program to execute a variety of processes described below. In this example, the server 2 comprises the application software 3, an XML generation function 4, an XML operation function 5, etc.

The application software 3 is a program. In this case, the application software 3 receives a request from the browser 1, transfers the received request to the XML generation function 4, makes the XML generation function generate a request in an XML format by referring to the database 6, extracts information from the request, returns the extracted information to the browser, and the like.

The XML generation function 4 converts the plurality of kinds of requests transferred from the application software 3 into requests in an XML format by referring to the database 6, and the like.

The XML operation function 5 performs a variety of operations, such as extracting information from the database 6 according to the request in an XML format, etc.

The database 6 stores a variety of information shown later in FIG. 7 for the purpose of easy retrieval.

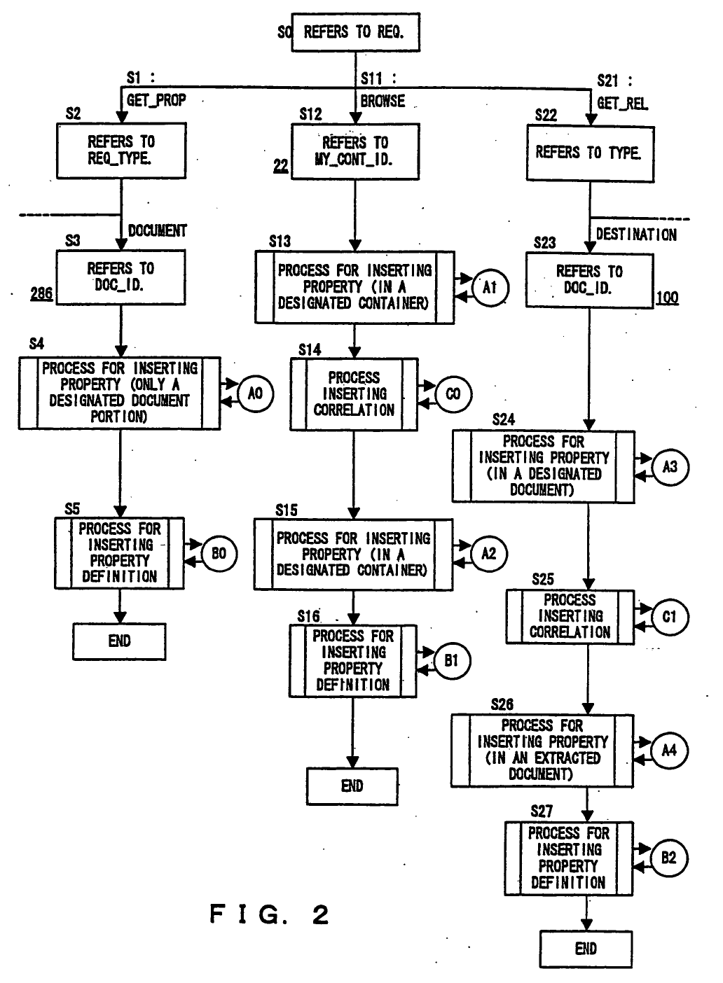

Next, the operation of the configuration shown in FIG. 1 is described in detail with reference to FIGS. 2 through 5.

FIG. 2 is a flowchart showing the operation of the present invention.

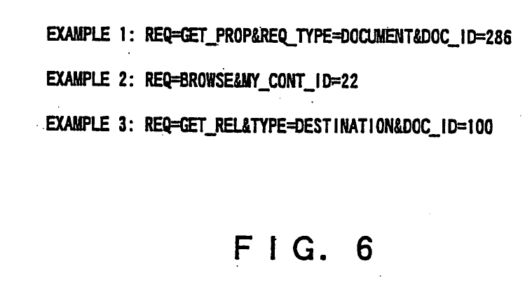

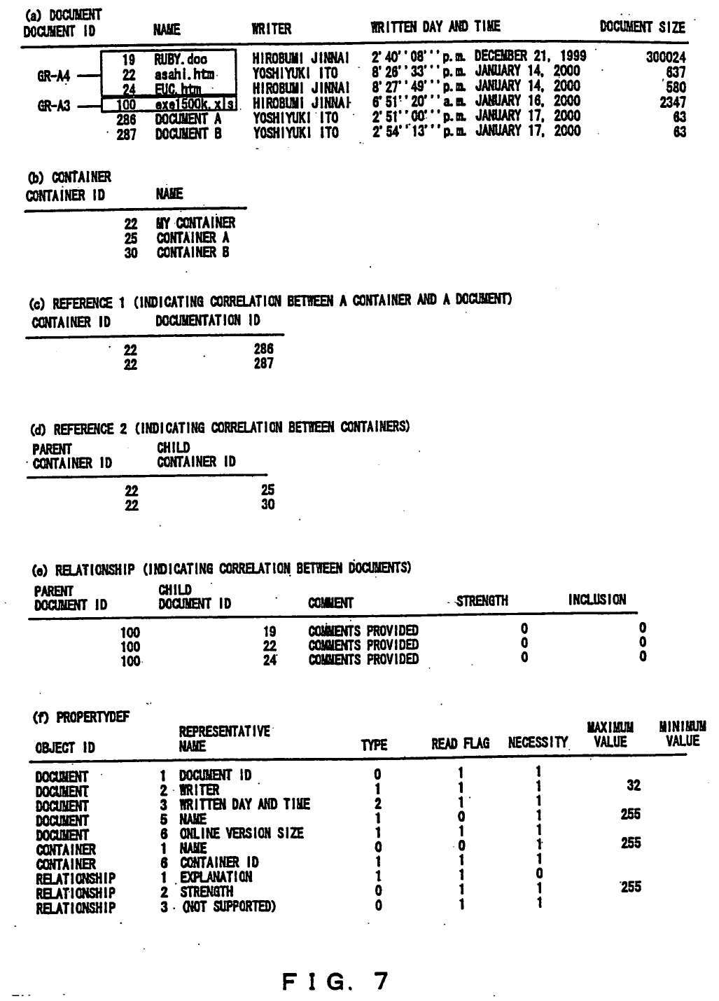

In FIG. 2, in S0, REQ is referenced. In this case, the REQ part of a request transmitted by the browser 1 shown in FIG. 1 via a network. For example, REQ (request) of the underlined part after ? (Example 1 shown later in FIG. 6) in the following address (address, including a request) is extracted and referenced.

http://www. (address of a home page)/cgi.exe?REQ=GET PROP&REQ TYPE=DOCUMENT&DOC ID=286

In this case, it is judged which of the followings is REQ referenced in S0.

GET PROP (in the case of Example 1 shown in FIG. 6)

BROWSE (in the case of Example 2 shown in FIG. 6)

CET REL (in the case of Example 3 shown in FIG. 6)

In the case of S1 where in S0, REQ (request) is referenced and CET PROP is detected, S2 and after are executed.

In S2, REQ TYPE is referenced. In this case, since REQ TYPE=DOCUMENT is described in REQ (request) of Example 1 shown in FIG. 6 and DOCUMENT is detected, the flow proceeds to S3. In other cases, corresponding processes are executed in the same way.

In S3, DOC ID is referenced. In this case, DOC ID=286 is described in REQ (request) of Example 1 shown in FIG. 6, 286 is detected.

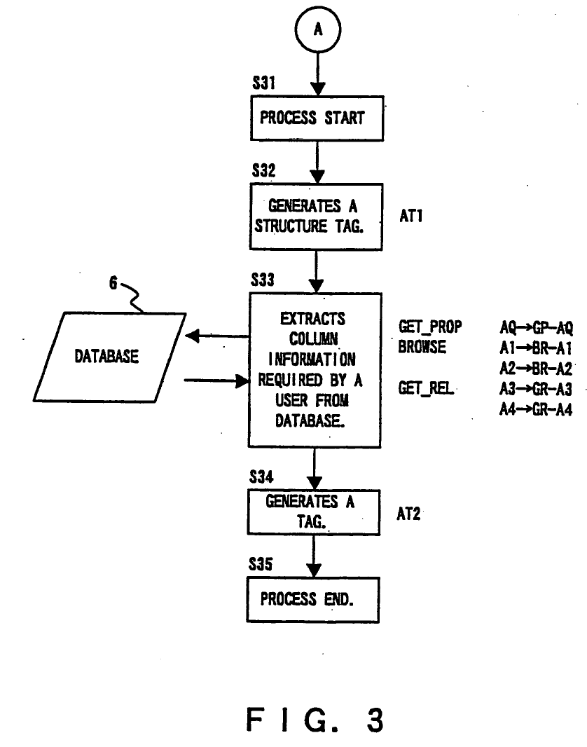

In S4, property is inserted (only a designated document portion). In this process, the following process of A (A0) shown in FIG. 3 is executed.

In S31 shown in FIG. 3, a process is started.

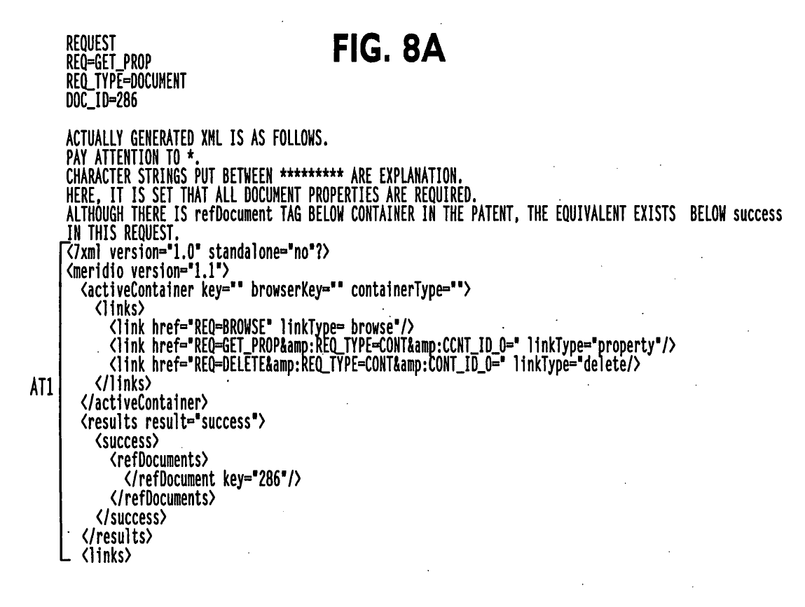

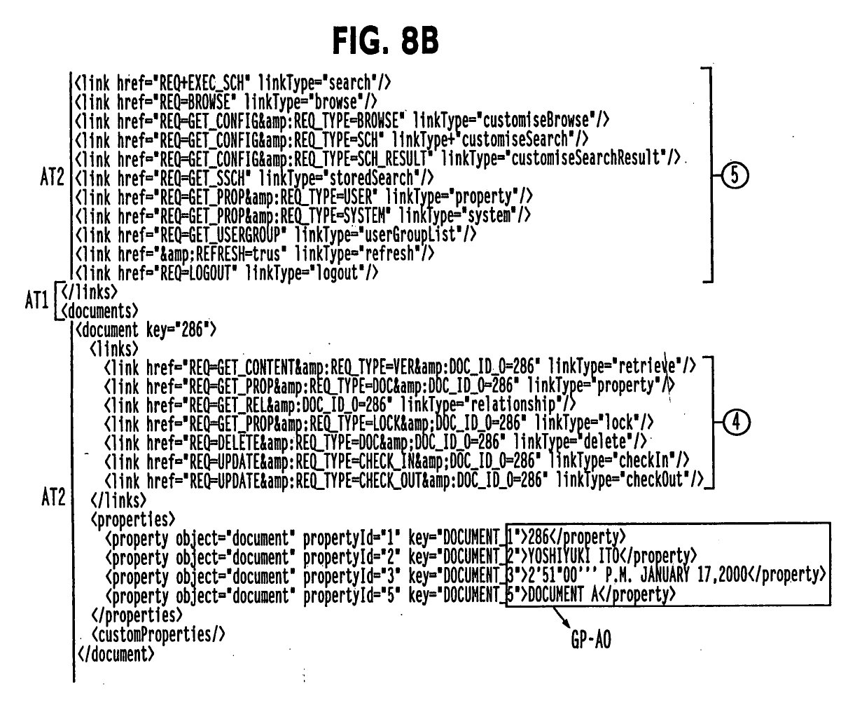

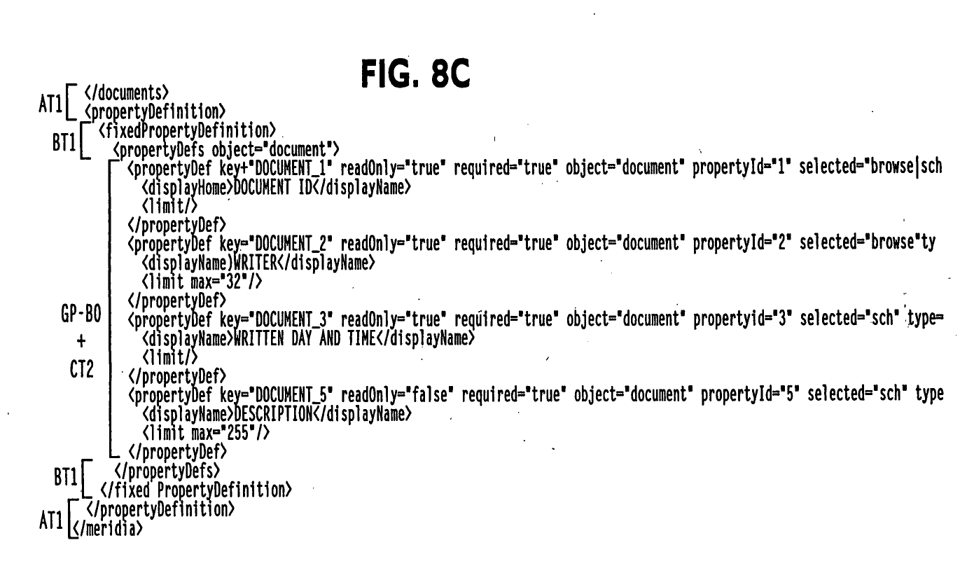

In S32, a structure tag is generated. In this case, for example, a structure tag is generated, as shown in part AT1 of the request (Example 1) in an XML format shown in FIG. 8 described later.

In S33, column information required by a user is extracted from a database. In this case, for example, the GP-A0 of the request in an XML format shown later in FIG. 8 is extracted from the database and is inserted.

In S34, a tag is generated. In this case, for example, a tag shown in part AT2 of the request in an XML format shown later in FIG. 8 is generated.

In S35, the process is terminated. Then, in this case, the flow returns to S4 shown in FIG. 2 and proceeds to S5.

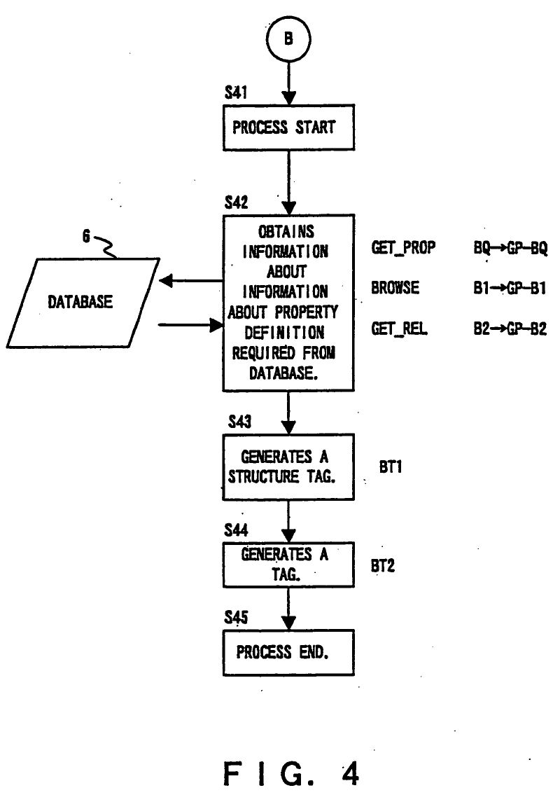

In S5, a process for inserting property definition is executed. In this process, the following process (B0) for inserting the information about property shown later in FIG. 4 is executed.

In S41 shown in FIG. 4 a process is started. In S42, information about property definition is obtained from the database 6. In this case, for example, part GP-B0 of the request in an XML format shown later in FIG. 8 is extracted from the database and is inserted.

In s43, a structure tag is generated. In this case, for example, a structure tag shown in part BT1 of the request in an XML format shown later in FIG. 8 is generated.

In S44, a tag is generated. In this case, for example, a tag shown in part BT2 of the request in an XML format shown later in FIG. 8 is generated.

In S45, the process is terminated. Then, in this case, the flow returns to S5 and is terminated.

In S0 described above, REQ (request) is, for example, Example 1 shown in FIG. 6, the REQ is referenced, GET PROP is detected, in S1 through S5 the request (Example 1) in an XML format shown later in FIG. 8 can be automatically generated (converted).

Similarly, in the case of S11 shown in FIG. 2 where in S0 REQ (request) is referenced and BROWSE is detected, S12 and after are executed.

In S12, MY CONT ID is referenced. In this case, MY CONT ID=22 is described in REQ (request) in Example 2 shown in FIG. 6 and 22 is detected.

In S13, property is inserted (in a designated container). In this process, the following process of A (A1) shown in FIG. 3 is executed.

In S31 shown in FIG. 3, a process is started.

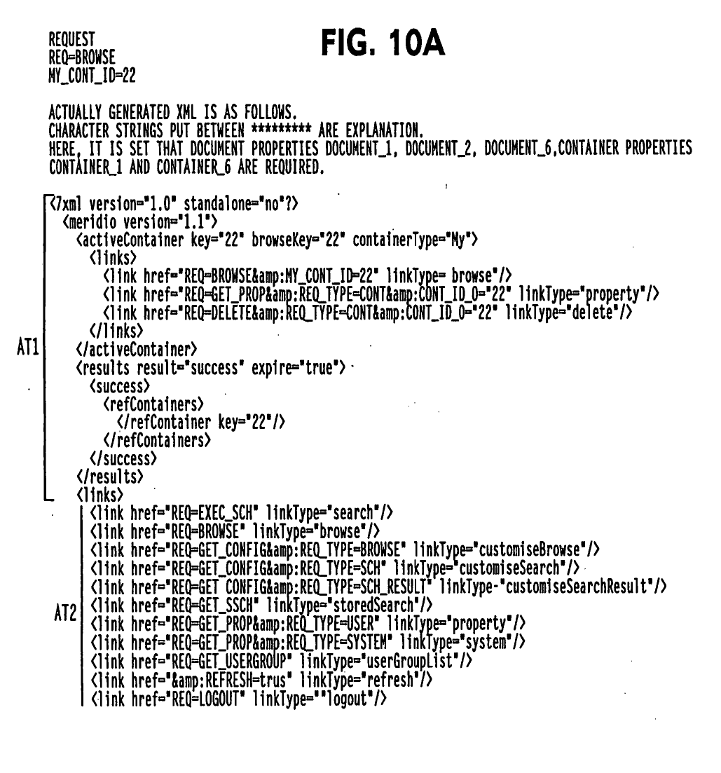

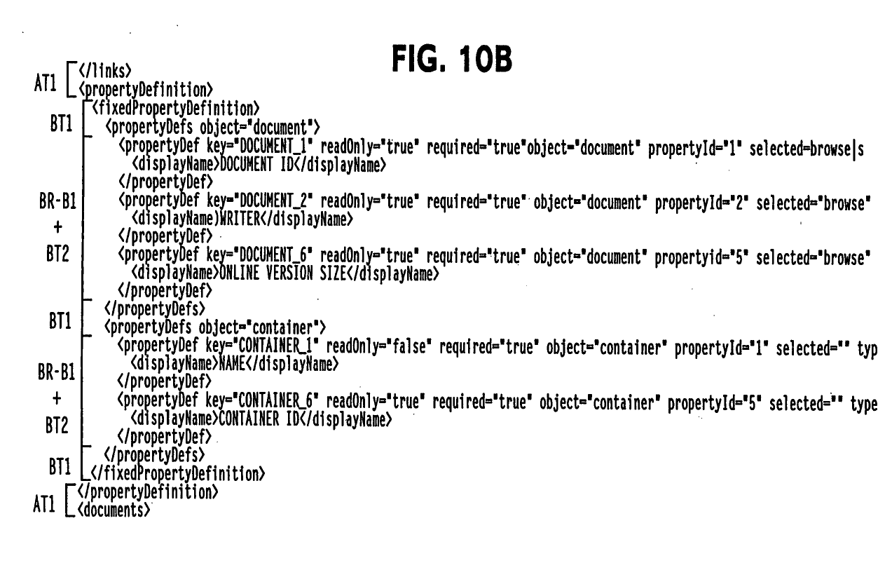

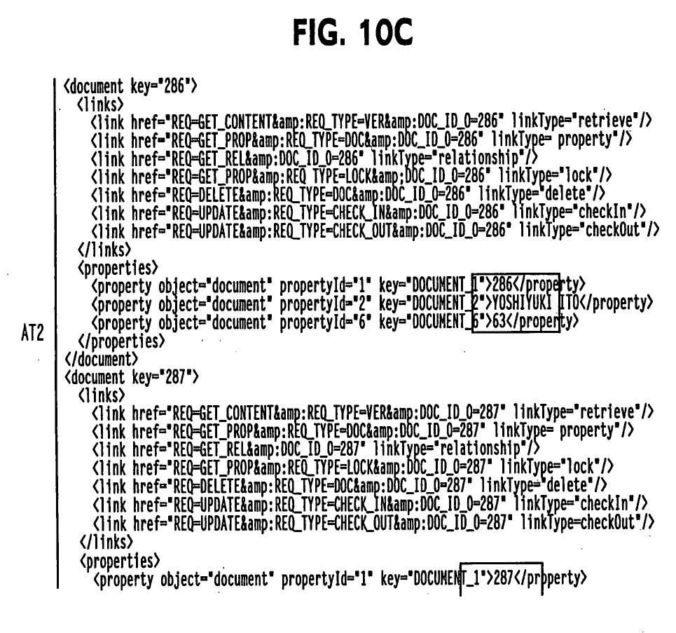

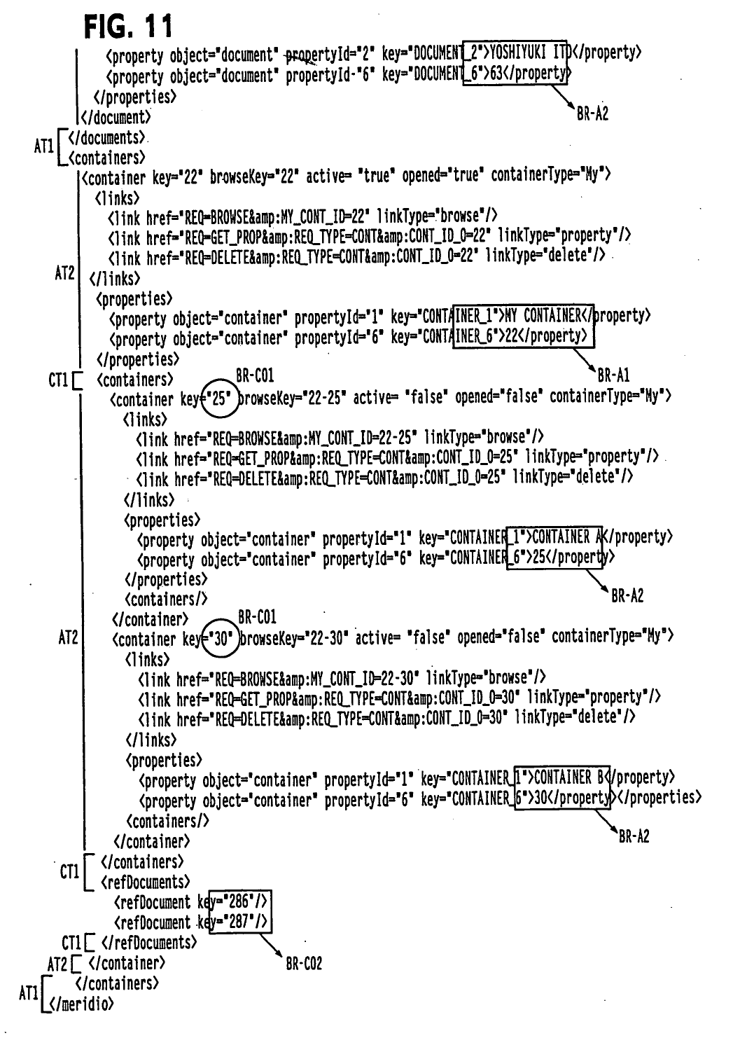

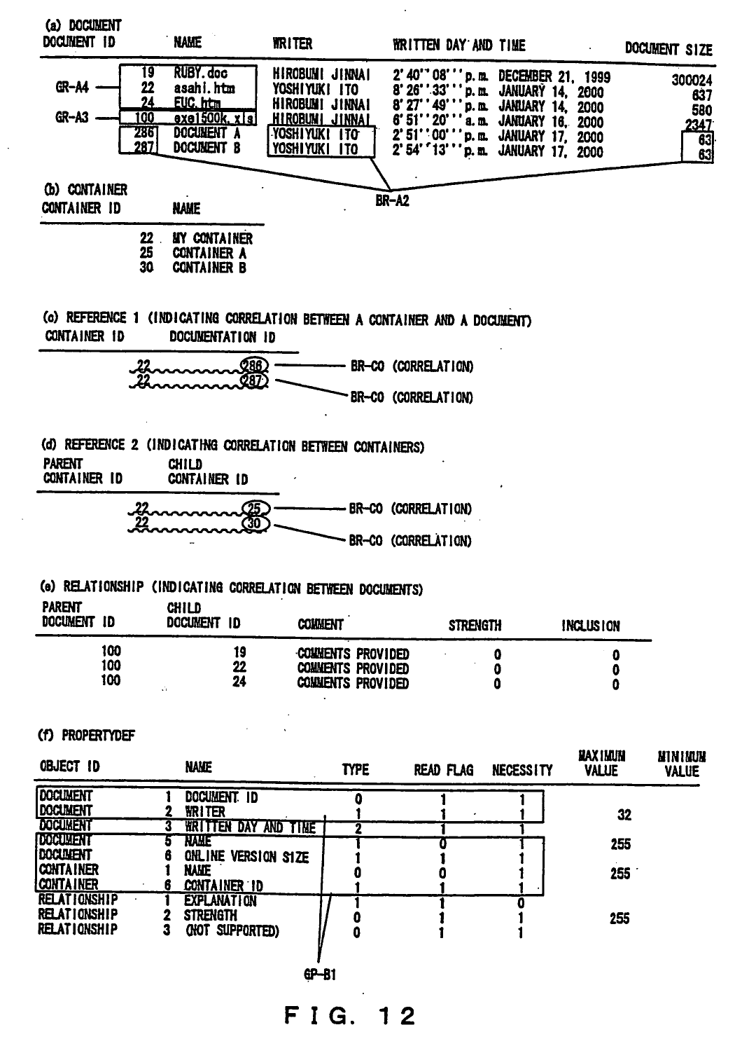

In S32, a structure tag is generated. In this case, for example, a structure tag is generated, as shown in part AT1 of the request (Example 2) in an XML format shown later in FIGS. 10 and 11.

In S33, column information required by a user is extracted from the database. In this case, for example, part BR-A1 of the request in an XML format shown later in FIG. 10 is extracted from the database and is inserted.

In S34, a tag is generated. In this case, for example, a tag shown in part AT2 of the request in an XML format shown later in FIGS. 10 and 11 is generated.

In S35, the process is terminated. Then, the flow returns to S13 and proceeds to S14.

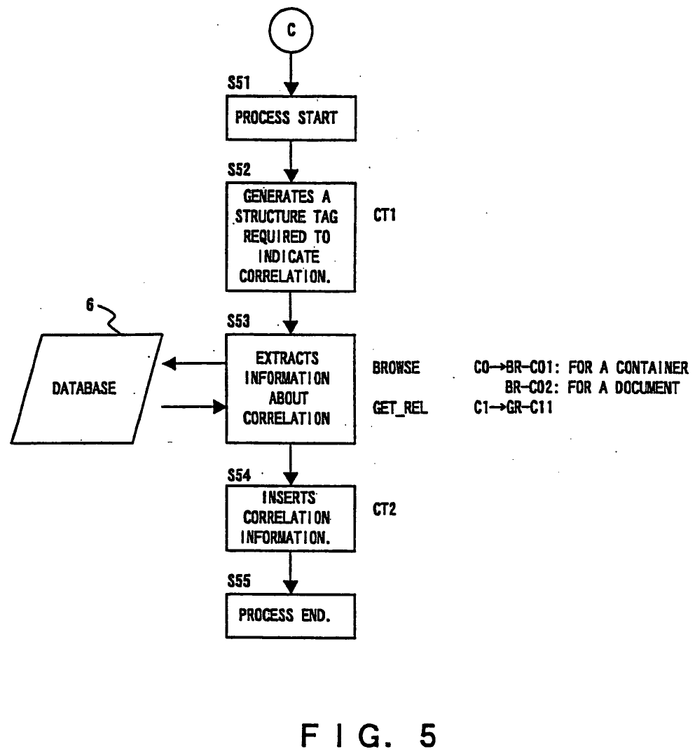

In S14, correlation is inserted. In this process, the following process of C (C0) shown in FIG. 5 is executed.

In S51 shown in FIG. 5, a process is started.

In S52 a structure tag required to indicate correlation is generated. In this case, for example, a structure tag shown in part CT1 of the request (Example 2) in an XML format shown later in FIGS. 10 and 11 is generated.

In S53, information about correlation is extracted. In this case, information about correlation is extracted from the database 6 and, for example, parts BR-CO1 and BR-CO2 of the request in an XML format shown later in FIGS. 10 and 11 are inserted.

In S54, correlation information is inserted. In this case, for example, part CT2 of the request in an XML format shown later in FIGS. 10 and 11 is inserted.

In S55, the process is terminated. Then, the flow returns to S14 and proceeds to S15.

In S15, property is inserted (in a designated container). In this process, the process of A (A2) shown in FIG. 3 is executed in the same way.

In S16, property definition is inserted. In this process, the process of B (B1) shown in FIG. 4 is executed in the same way.

In S0 described above, if REQ (request) is, for example, Example 2 shown in FIG. 6, the REQ is referenced, BROWSE is detected, in S11 through S16 the request (Example 2) in an XML format shown later in FIGS. 10 and 11 can be automatically generated (converted).

In the case of S21 shown in FIG. 2 where in S0 REQ (request) is referenced and GET REL is detected, S22 and after are executed.

In S22, TYPE is referenced. In this case, since TYPE=DESTINATION is described in REQ (request) of Example 3 shown in FIG. 6 and DESTINATION is detected, the flow proceeds to S23. In other cases, respective corresponding processes are executed in the same way.

In S23, DOC ID is referenced. In this case, DOC ID=100 is described in REQ of Example 3 shown in FIG. 6, and 100 is detected.

In S24, property is inserted (in a designated document). In this process, the following process of A (A3) shown in FIG. 3 is executed.

In S31 shown in FIG. 3, a process is started.

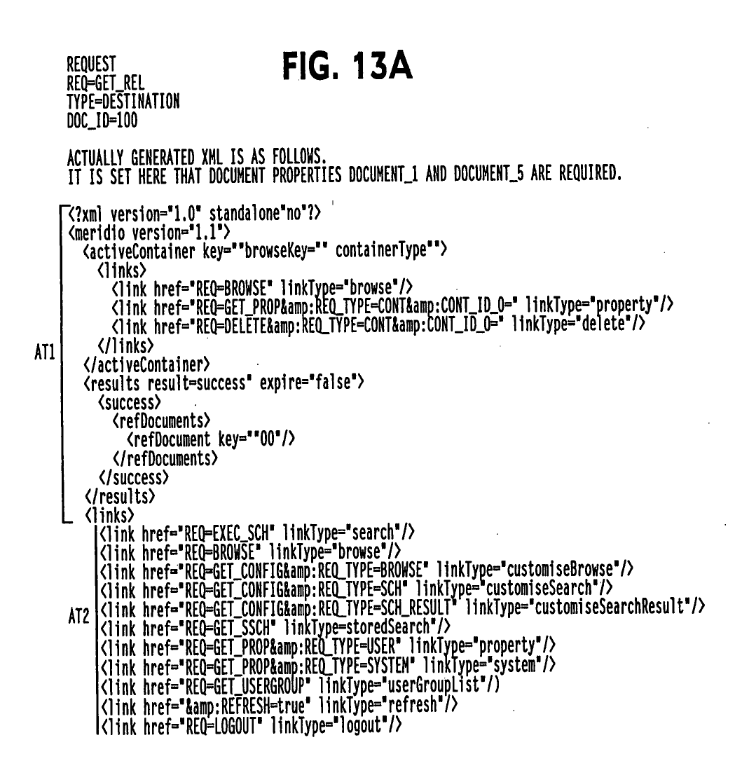

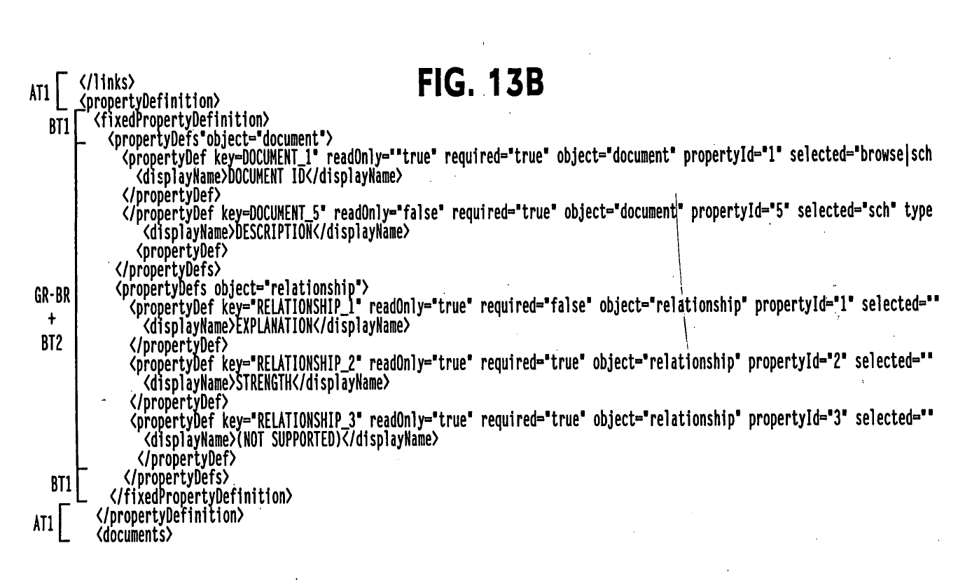

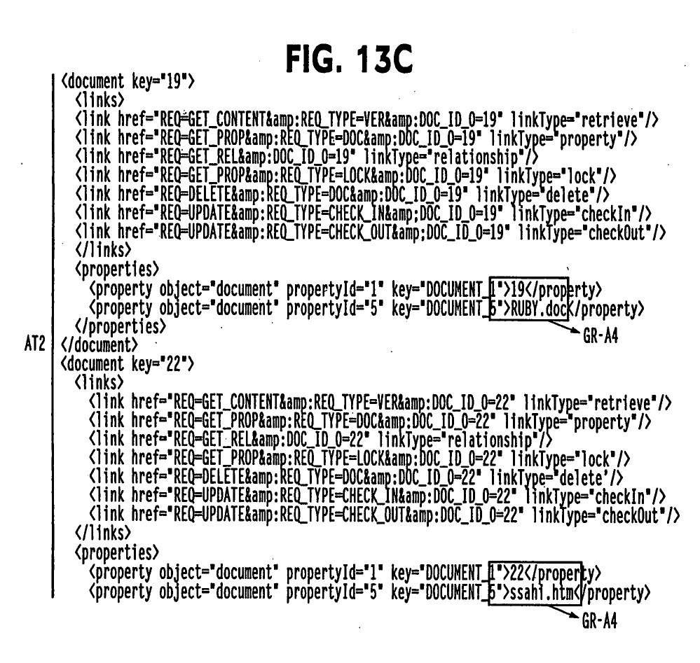

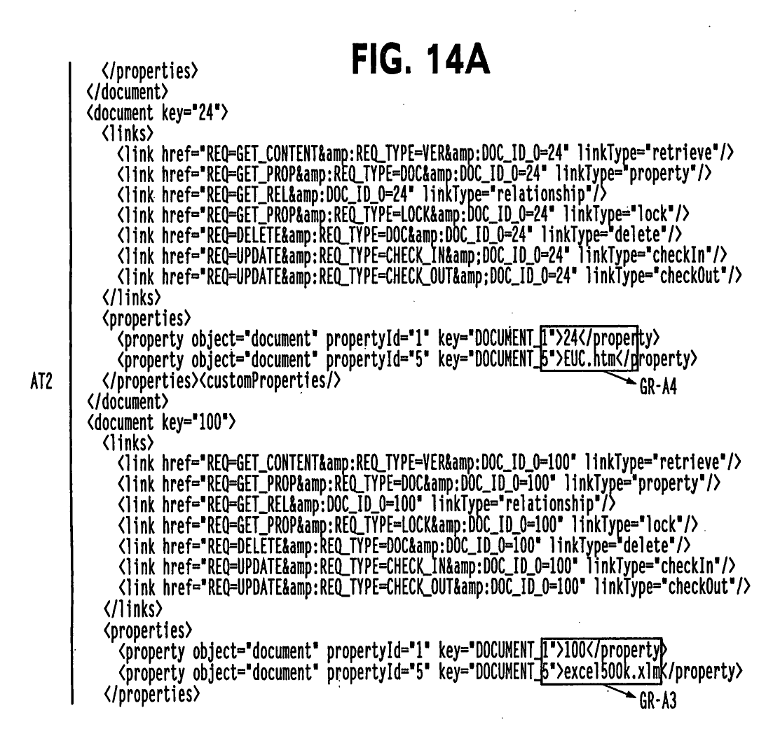

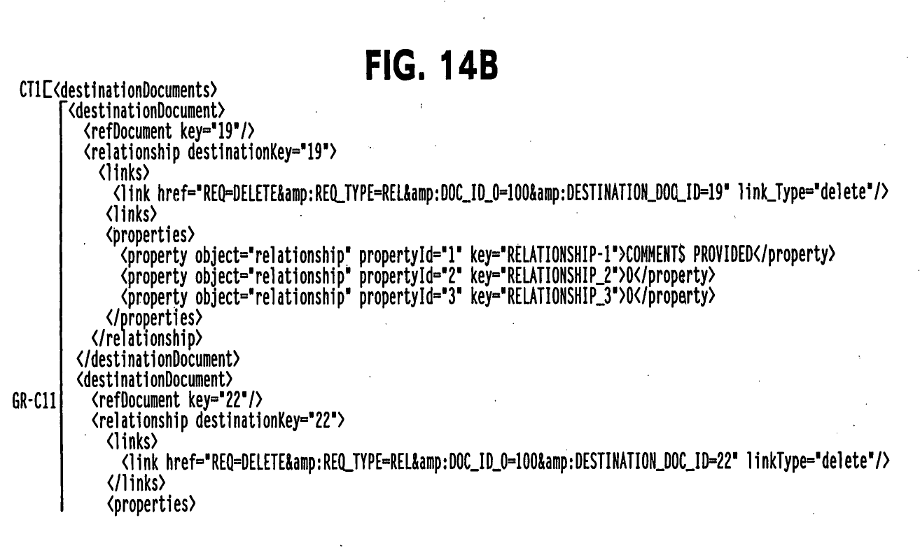

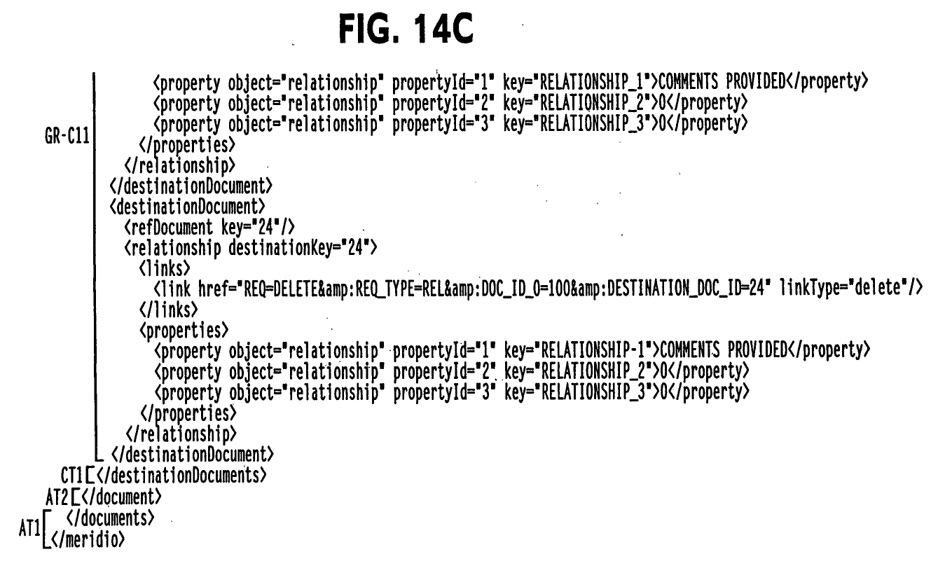

In S32, a structure tag is generated. In this case, a structure tag shown in part AT1 of the request (Example 3) in an XML format shown later in FIGS. 13 and 14 is generated.

In S33, column information required by a user is extracted from the database. In this case, part GR-A3 of the request in an XML format shown later in FIGS. 13 and 14 is extracted from the database and is inserted.

In S34, a tag is generated. In this case, a tag shown in part AT2 of request in an XML format shown later in FIGS. 13 and 14 is generated.

In S35, the process is terminated. Then, the flow returns to S24 shown in FIG. 2 and proceeds to S25.

In S25, correlation is inserted. In this process, the following process of C (C1) shown in FIG. 5 is executed.

In S51 shown in FIG. 5, a process is started.

In S52, a structure tag required to indicate correlation is generated. In this case, a structure tag shown in part CT1 of the request (Example 3) in an XML format shown in FIGS. 13 and 14 is generated, In S53, information about correlation is extracted. In this case, information about correlation is extracted from the database 6, and, for example, part GR-C11 of the request in an XML format shown later in FIGS. 13 and 14 is inserted.

In S54, correlation information is inserted. In this case, for example, CT2 of an XML format shown later in FIGS. 13 and 14 is inserted.

In S55, the process is terminated. Then, in this case, the flow returns to S25 and proceeds to S26.

In S26, property is inserted (in an extracted document). In this process, the process of A (A4) shown in FIG. 3 is executed in the same way.

In S27, property definition is inserted. In this process, the process of B (B2) shown in FIG. 4 is executed in the same way.

In S0 described above, if REQ (request) is, for example, Example 3 shown in FIG. 6, the REQ is referenced, GET REL is detected, and in S23 through S27 the request (Example 3) in an XML format shown later in FIGS. 13 and 14 can be automatically generated (converted).

FIG. 3 is a flowchart showing the detailed operation of the present invention (process for inserting property, A). As already described with reference to FIG. 2, this flowchart describes the detailed process for inserting the property (property of a designated document, a designated container, an extracted document, etc.) of a request (REQ) in the request in an XML format shown in FIGS. 8, 11, 12, 13 and 14, in the flowchart shown in FIG. 2 (for detail, see the description on S31 through S35 shown in FIG. 2).

FIG. 4 is a flowchart showing the detailed operation of the present invention (information about property, B). As already described in FIG. 2, this flowchart describes the detailed process for inserting the property (property definition) of a request (REQ) in the request in an XML format shown in FIGS. 8, 11, 12, 13 and 14, in the flowchart shown in FIG. 2 (for detail, see the description on S41 through S45 shown in FIG. 2).

FIG. 5 is a flowchart showing the detailed operation of the present invention (a method for inserting correlation). As already described in FIG. 2, this flowchart describes the detailed process for inserting the correlation of a request (REQ) in the request in an XML format shown in FIGS. 8, 11, 12, 13 and 14, in the flowchart shown in FIG. 2 (for detail, see the description on S51 through S55 shown in FIG. 2).

FIG. 6 examples of the requests of the present invention. These are examples of REQs (requests) in S1, S11 and S21 shown in FIG. 2 as follows.

Example 1: REQ=GET PROP&REQ TYPE=DOCUMENT&DOC ID=286

Example 2: REQ=BROWSE&MY CONT ID=22

Example 3: REQ=GET REL&TYPE=DESTINATION&DOC ID=100

These REQs (requests) are transmitted from the browser (client) 1 to the server 2 via a network, and they are described after (the home address of the related server 2)/cgi.exe?. The details are described below using Example 1.

(1) The server 2 receives http://www.(home page address)/cgi.exe?REG=GET PROP&REQ TYPE=DOCUMENT&DOC ID=286

(2) Request in the underlined part of (1) is inserted in void main (int argc, char* argv[ ], char* envp[ ]//envp as a oart of an environmental variable.

(3) Request of (2) (request in the underlined part of (1)) from a user is inserted in MWISimpleCall MSCobj (envp);//envp (request extracted from the environmemtal variable of (2) is inserted using MWISimpleCall class).

(4) A request in an XML format to be returned (see FIGS. 8, 11, 12, 13 and 14) is generated (converted) and inserted in MMIRequest (MSCobj.toMWQuery( ), returnedXm 1);//returnedXml.

(5) Then, information is extracted from retunedXml of (4), is converted into an HTML format and is returned to the user (browser 1).

FIG. 7 shows an example of the database used in the present invention.

FIG. 7(a) shows an example of a DOCUMENT(document) database. Here, the following information shown in FIG. 7(a) is related and registered.

Document ID:

Name:

Writer:

Written day and time:

Document size:

FIG. 7(b) shows an example of a CONTAINER (container) database. Here, the following information shown in FIG. 7(b) is related and registered.

Container ID:

Name:

FIG. 7(c) shows an example of a REFERENCE1 (reference 1) database (indicating correlation between a container and a document). Here, the following information shown in FIG. 7(c) is related and registered.

Container ID:

Document ID:

FIG. 7(d) shows an example of a REFERENCE2 (reference 2) database (indicating correlation between containers). Here, the following information shown in FIG. 7(d) is related and registered.

Parent container ID:

Child container ID:

FIG. 7(e) shows an example of a RELATIONSHIP (relationship) database (indicating correlation between documents). Here, the following information shown in FIG. 7(e) is related and registered.

Parent document ID:

Child document ID:

Comment:

Strength:

Inclusion:

FIG. 7(f) shows an example of a PROPERTYDEF database. The following information shown in FIG. 7(f) is related and registered.

Object ID:

Representative Name:

Type:

Read flag:

Necessity:

Maximum value:

Minimum value

FIG. 8 shows an example of the XML (Example 1) of the present invention. This request in an XML format is converted from REQ (request) of Example 1 shown in FIG. 6 according to the flowcharts shown in FIGS. 2 through 5. Symbols used in FIG. 8 (AT1, AT2, BT1, GP-B0, CT2, GP-A0, etc.) are generated in the respective positions described in the flowcharts shown in FIGS. 2 through 5 and they indicate the respective correspondences.

(4) shown in FIG. 8 is link information. A list of requests (list of request templates) related to document ID=286 is generated in advance and is set there. A request can be arbitrarily selected/designated and set there.

Similarly, (5) shown in FIG. 8 is also link information. A list of requests (list of request templates) related to the entire or highest-order document is generated in advance and is set there. A request can be arbitrarily selected/designated and set there.

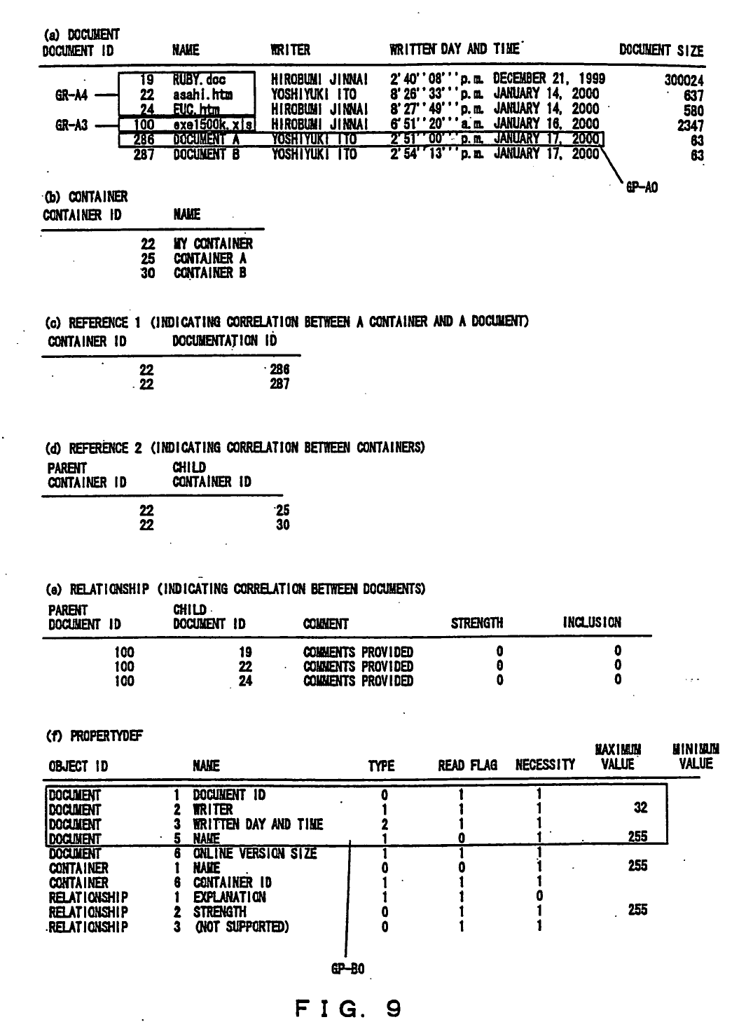

FIG. 9 shows an example of the database (Example 1) used in the present invention. Symbols described in FIG. 9 (GP-A0, GP-B0) indicate information extracted from the respective parts corresponding to the symbols.

FIGS. 10 and 11 show an example of XML (Example 2) of the present invention. This request in an XML format is converted from REQ (request) of Example 2 shown in FIG. 6 according to the flowcharts shown in FIGS. 2 through 5. Symbols described in FIGS. 10 and 11 (AT1, AT2, BR-A1, BR-A2, etc.) are generated in the respective positions described in the flowchart and indicate the respective correspondences.

FIG. 12 shows an example of the database (Example 2) used in the present invention. Symbols described in FIG. 12 (BR-A2, GP-B1, BR-C0, etc.) indicate respective pieces of information extracted from the respective parts corresponding to the symbols shown in FIGS. 10 and 11.

FIGS. 13 and 14 show an example of XML (Example 3) of the present invention. This request in an XML format is converted from REQ of Example 3 shown in FIG. 6 according to the flowcharts shown in FIGS. 2 through 5. Symbols described in FIGS. 13 and 14 (AT1, AT2, GR-A3, GR-A4, etc.) are generated in the respective positions described in the flowcharts shown in FIGS. 2 through 5 and they indicate the respective correspondences.

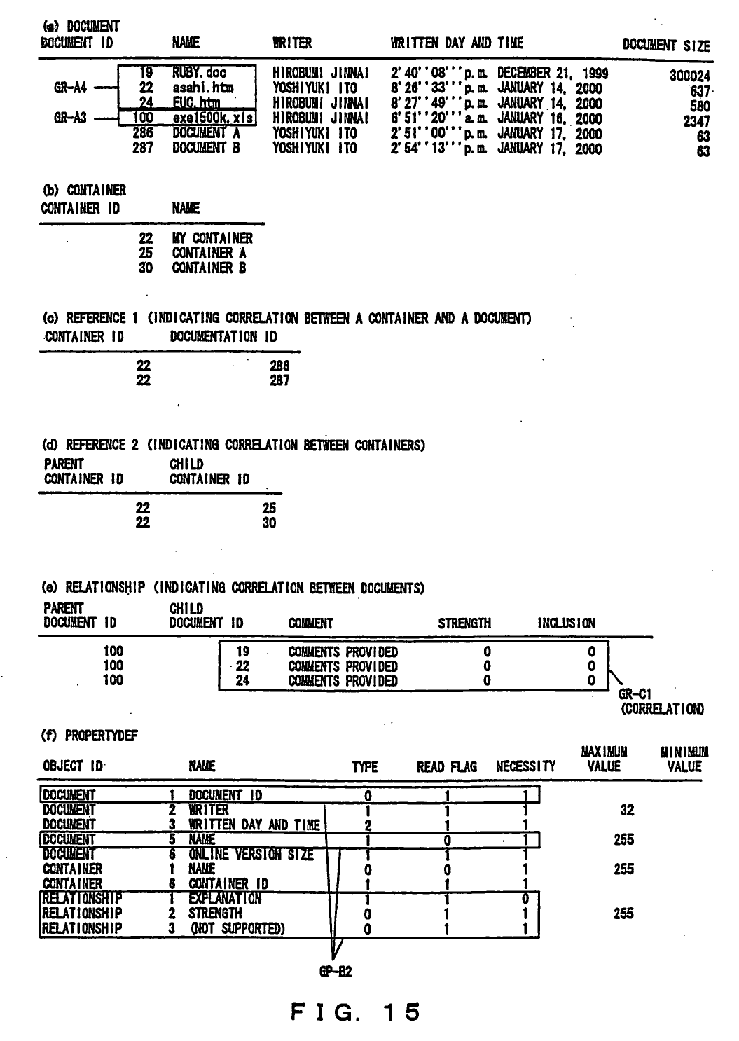

FIG. 15 shows an example of the database (Example 3) used in the present invention. Symbols described in FIG. 15 (BR-A3, GR-A4, Gr-C1, GR-B2, etc.) indicate respective pieces of information extracted from the respective parts corresponding to the symbols shown in FIGS. 13 and 14.

In this way, according to the present invention, since the server 2 receives requests from the browser 1, a function called up from the application software 3 of the server 2 converts the plurality of kinds of requests into requests in an XML format by referring to the database 6, transfers the request to the application software 3, the application software 3 extracts results and returns the results to the browser 1, requests in an XML format can be generated from a plurality of kinds of requests and a variety of desired information can be easily and rapidly returned to a user. If application software for publicizing the information of the database 6 to users is generated, work efficiency can be improved using an interface most familiar to an engineer generating the application software.

What is claimed is:

1. An information extraction device for extracting information corresponding to a request from a database, comprising:
a function called up from application software, for converting a plurality of kinds of requests into requests in an XML format by referring to a database and returning results.

2. The information extraction device according to claim 1, wherein a list of requests related to the generated requests in an XML format that can be arbitrarily selected and set, is linked and provided.

3. The information extraction device according to claim 1 or 2, wherein a list of requests related to information designated in the generated requests in an XML format that can be arbitrarily selected and set, is linked and provided.

4. A computer-readable storage medium on which is recorded a program for extracting information corresponding to a request from a database as an information extraction device and converting a plurality of kinds of requests into requests in an XML format by referring to a database as a function called up from application software.
